(19) United States
(12) Patent Application Publication
(10) Pub. No.: US 2025/0289149 A1
(43) Pub. Date: Sep. 18, 2025

(54) RADIONUCLIDE SOURCE MANIPULATION SYSTEMS AND RELATED METHODS

(71) Applicant: ARTBIO, Inc., Cambridge, MA (US)

(72) Inventors: Gjermund Fjeld Olsen, Fjerdingby (NO); Tanja Aarvak, Oslo (NO); Judit Tjelmeland Oestby, Kraakstad (NO); Olga Salina, Ski (NO); John Emmanuel Aristidou, Cambridge (GB)

(73) Assignee: ARTBIO, Inc., Cambridge, MA (US)

(21) Appl. No.: 19/077,776

(22) Filed: Mar. 12, 2025

Related U.S. Application Data
(60) Provisional application No. 63/565,868, filed on Mar. 15, 2024.

(51) Int. Cl. B25J 15/08; G21G 4/08

(52) U.S. Cl. CPC B25J 15/086; G21G 4/08

(57) ABSTRACT

Some aspects are generally related to gripper systems for manipulating holders and/or containers disposed therein for use with radionuclide generators. In some embodiments, the gripper system further facilitates the insertion and/or removal of a stopper from the container, which may maintain a sterility of an interior of the container before and/or after exposure of the container to radionuclides from the radionuclide generator.

### RELATED APPLICATIONS

This application claims priority under 35 U.S.C. § 119 (e) to U.S. Provisional Patent Application No. 63/565,868, filed Mar. 15, 2024, which is incorporated herein by reference in its entirety for all purposes.

### FIELD

Disclosed embodiments are related to a radionuclide source manipulation system configured for use with a radionuclide generator, and related methods of use.

### BACKGROUND

Radionuclides such as lead 212 (²¹²Pb) may be used in various applications. For example, ²¹²Pb may be used as a therapeutic in radiation treatments for various health conditions, including various cancers. Lead 212 may be formed as a progeny radionuclide in the decay chain of a parent radionuclide such as thorium, radium, or radon. Typically, containers for capturing and using a desired progeny radionuclide are manipulated by a user with personal shielding and/or remotely controlled with robotic manipulation systems.

### SUMMARY

In some embodiments, a gripper system for manipulating a container of a radionuclide generator includes: one or more locks configured to selectively engage with and retain a holder including an interior volume sized and shaped to receive the container disposed therein; a seal configured to engage with a stopper positioned in an opening of the of the container when the gripper is engaged with the holder with the container disposed therein; and a vacuum source configured to apply a vacuum to the seal when the seal is positioned against the stopper of the container.

In some embodiments, a gripper system for manipulating a container of a radionuclide generator includes: a holder including an interior volume sized and shaped to receive the container disposed therein, wherein the holder includes a first portion and a second portion configured to be removably attached to the first portion, wherein the second portion includes an opening formed therein configured to permit a neck of the container to extend through the opening while retaining the container in the interior volume of the holder; and one or more locks configured to selectively engage with and retain the holder.

In some embodiments, a method includes: selectively gripping a holder including an interior volume with a container disposed therein with a gripper system; positioning the holder including the container within a receptacle of a radionuclide generator; and releasing the container and holder while removing a stopper from the container with the gripper system.

In some embodiments, a method includes: receiving a container within an interior volume of a first portion of a holder; selectively attaching a second portion of the holder to the first portion such that a neck of the container extends through an opening of the second portion; retaining the container in the interior volume of the first portion of the holder with the second portion; selectively gripping the holder with a gripper system; and positioning the holder including the container within a receptacle of a radionuclide generator using the gripper system.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram of a radioactive material series decay chain, according to some embodiments;

FIG. 2 is a side view schematic diagram of a radionuclide generator, according to some embodiments;

FIG. 3 is a cutaway schematic diagram of a radionuclide generator, according to some embodiments;

FIG. 4 is a side view of a gripper system, according to some embodiments;

FIG. 5 is a side view of a gripper system gripping a holder, according to some embodiments;

FIG. 6 is a cross-sectional view of a gripper system gripping a holder with a container disposed therein, according to some embodiments;

FIG. 7 is a cross-sectional view of a gripper system after releasing a holder with a container disposed therein, according to some embodiments;

FIG. 8 is a cross-sectional, cross sectional perspective view of a gripper system, according to some embodiments;

FIG. 9 is a method flow diagram of an example method for using a gripper system, according to some embodiments; and

FIGS. 10A-10G are a series of images of a gripper system being used to position a holder and container disposed therein into a radionuclide generator, according to some embodiments.

### DETAILED DESCRIPTION

Radionuclides may be used for a variety of applications in such fields as medicine, biology, physics, and other industries. Some radionuclides which possess relatively short half-lives may be appropriate for use in various medical applications, such as targeted alpha-particle therapy (TAT). Radionuclides possessing relatively short half-lives may be preferable for some applications so they can be administered to a patient to treat a particular condition (e.g., any of various cancers such as prostate or carcinoid cancers) while limiting the patient's time of exposure to radioactivity. Treatments with radionuclides having shorter half-lives may therefore result in fewer and/or less severe side effects than treatments with radionuclides having longer half-lives. In some applications, lead 212 (²¹²Pb) may be a desirable radionuclide for use in TAT or other treatments or applications because it has a half-life of about 10.6 hours.

Radionuclides having short half-lives may be generated within a radionuclide generator closer to a point of use. This may include the use of a container that may be used in tandem with the radionuclide generator that is used to capture the progeny radionuclide such as ²¹²Pb within the container. However, the manipulation and transport of such containers is oftentimes difficult due to the radioactive nature of the materials involved resulting in the use of shielded gloveboxes, tongs, and/or robotic manipulators. Additionally, such systems may not have the dexterity to perform certain actions due to, for example, the use of non-standard containers that interface easily with existing systems, the removal of stoppers being difficult with existing manipulators, and certain positioning and manipulation operations may be difficult or impossible to perform.

In view of the above, the Inventors have recognized that it is desirable to provide methods and systems that facilitate the manipulation of containers for use with radionuclide generators. This may both facilitate use of various types of radionuclide generators while also helping to minimize and/or eliminate undesirable contamination as well as exposure of a user to radiation when manipulating the container.

The inventors have recognized the benefits associated with the use of holders that various sized and shaped containers may be disposed within. Specifically, a holder may include features that may facilitate the retention of a container therein while also permitting easy manipulation of the holder itself. For example, a manipulator system may include one or more locks that are configured to selectively engage and retain the holder for direct and/or indirect manipulation by a user. In some instances, this may include selectively retaining the holder on a distal portion of a gripper body when the one or more locks are in a locked rather than unlocked configuration in which the holder may be removed from the gripper body. Additionally, in some embodiments, the holder may be configured to prevent removal of the container from the holder in a first configuration and a permit removal of the container from the holder in a second configuration.

The above embodiment may be advantageous because the various shapes and/or sizes of different containers may be difficult to manipulate using tongs and/or a manipulator used with the radionuclide generator (e.g., which may be used to minimize exposure to a user to the radiation generated at the radionuclide generator). However, the holder may be sized and shaped to interface with the gripper system which may be easily manipulated. Accordingly, the holder may facilitate such manipulation of the container by allowing the gripper system to manipulate the holder and the container disposed therein for use with the radionuclide generator.

In addition to the above, in some embodiments, it may be desirable to remove a stopper of a container using the disclosed gripping system. This may help to reduce contamination during manipulation and radionuclide generation. Accordingly, in some embodiments, a gripper system may be configured to remove and/or insert a stopper from an opening of a container while it is held in the associated holder. To facilitate such a functionality, the disclosed gripper systems may include a seal that may be placed in contact with the stopper of the container when a gripper body of the system is engaged with a holder in which the container is disposed. A vacuum source in fluid communication with the sealed volume between the gripper and stopper may be operated to selectively apply a suction force to the stopper. Thus, when the seal is engaged with the stopper and the suction force is applied, relative movement of the gripper body to the holder and container disposed therein may be used to selectively remove a stopper from or insert a stopper into an opening of the container.

The seal may comprise any of a variety of shapes or sizes, according to some embodiments. In some embodiments, the seal may comprise an O-ring, a conical elastomeric seal (e.g., a suction cup), a flat elastomeric surface, and/or any other shape and/or configuration of a seal for facilitating the formation of a vacuum between a stopper positioned against the seal. The material of the seal may be any of a variety of materials, in some cases. For example, the material of the seal may comprise an elastomeric material and/or any other sufficiently compliant material, though rigid seals may also be used in some embodiments. In some specific embodiments, the silicone, a fluorocarbon, a chlorocarbon (e.g., neoprene), a rubber (e.g., butyl or nitrile rubber), or other appropriate material.

In some embodiments, a seal may be sufficiently elastic and resistant to radiation such that it may be used repeatedly (e.g., at least at least 100 times, at least 1,000 times and/or no more than 2,000 times, no more than 5,000 times, and no more than 10,000 times) to manipulate a container and holder relative to a radionuclide generator while the seal retains its ability to form a vacuum when a vacuum source is operatively coupled to it and it is positioned against a surface (e.g., a stopper).

To provide a desired amount of sealing, in some embodiments, a seal may exhibit a desired amount of compression set which may be measured by an ASTM D395 standard test. The compression set of the seal, in some embodiments, is less than or equal to 40%, less than or equal to 30%, less than or equal to 20%, less than or equal to 15%, less than or equal to 10%, less than or equal to 5%, less than or equal to 2%, or less than or equal to 1%.

In some embodiments, the material of the seal may have a Young's modulus such that facilitates the formation of a vacuum when the seal is positioned against a stopper and a vacuum source is operatively coupled to the seal. In some embodiments, Young's modulus of the seal is greater than or equal to 0.1 MPa, greater than or equal to 0.2 MPa, greater than or equal to 0.3 MPa, greater than or equal to 0.5 MPa, greater than or equal to 1 MPa, greater than or equal to 2 MPa, greater than or equal to 3 MPa, greater than or equal to 5 MPa, greater than or equal to 10 MPa, greater than or equal to 20 MPa, greater than or equal to 30 MPa, or greater than or equal to 40 MPa. In some embodiments, the Young's modulus of the seal is less than or equal to 50 MPa, less than or equal to 40 MPa, less than or equal to 30 MPa, less than or equal to 20 MPa, less than or equal to 10 MPa, less than or equal to 5 MPa, less than or equal to 3 MPa, less than or equal to 2 MPa, less than or equal to 1 MPa, less than or equal to 0.5 MPa, less than or equal to 0.3 MPa, or less than or equal to 0.2 MPa. Combinations of the foregoing ranges are possible (e.g., greater than or equal to 0.1 MPa and less than or equal to 50 MPa). Other ranges are also possible.

Any appropriate type of vacuum source may be used with any of the embodiments of a gripper system disclosed herein. In some embodiments, appropriate vacuum sources may include a jet ejector, compressed gas source, a positive displacement pump (e.g., a diaphragm pump, a screw pump, a rotary vane pump), a centralized vacuum source, and/or any other appropriate type of vacuum source. Other vacuum sources are also possible, as this disclosure is not so limited.

The seal and vacuum source, in some embodiments, may be configured to apply a force to a stopper positioned adjacent to the seal during extraction from a container. In some embodiments, as described elsewhere herein, the applied force may facilitate the removal of the stopper when releasing the holder with the container disposed therein by the gripper system. The pressure associated with the vacuum formed by the vacuum source, in some embodiments, may be less than or equal to 100 kPa, less than or equal to 90 kPa, less than or equal to 80 kPa, less than or equal to 70 kPa, less than or equal to 60 kPa, less than or equal to 50 kPa, less than or equal to 40 kPa, less than or equal to 30 kPa, less than or equal to 20 kPa, or less than or equal to 10 kPa. In some embodiments, the seal and vacuum source may be configured to apply the force (e.g., a suction force) to the stopper positioned adjacent to the seal in an opening of the container. The force applied by the seal and vacuum may be sufficient to remove the stopper from the opening of the container when the gripper system releases the holder and container disposed therein in a radionuclide generator, in some embodiments.

Advantageously, the gripper system, methods, and other concepts disclosed herein may facilitate gripping and manipulating the container and/or a holder with the container disposed therein to be placed in the radionuclide generator. The use of a holder, as described in more detail elsewhere herein, may be configured to receive non-standard sized containers therein, which may allow the gripper system to manipulate such non-standard sized containers. Additionally, the gripper system described herein is, in some embodiments, designed to be incorporated into existing workflows of radionuclide generators, as the gripper system may be sized and adapted to be manipulated by tongs and/or a manipulator. These design considerations facilitate the use of standard and non-standard containers with radionuclide generators that may be sized and shaped to receive a holder in which the container may be disposed while advantageously removing the user from possible exposure to materials used near the gripper system, e.g., radionuclide generating materials.

Furthermore, the functionality of the gripper system to remove and/or replace the stopper of the container, as described elsewhere herein, is further synergistic with typical workflows for using a radionuclide generator with tongs, shielded gloveboxes, and/or manipulators. That is, while such systems may be difficult to use to remove or replace a stopper on a container, the gripper system may be easily used with such systems to add this functionality to the workflow. Such dexterity to remove and replace the stopper may also result in improved sterility of the container due to reduced handling while also minimizing exposure of the container to the surrounding environment.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

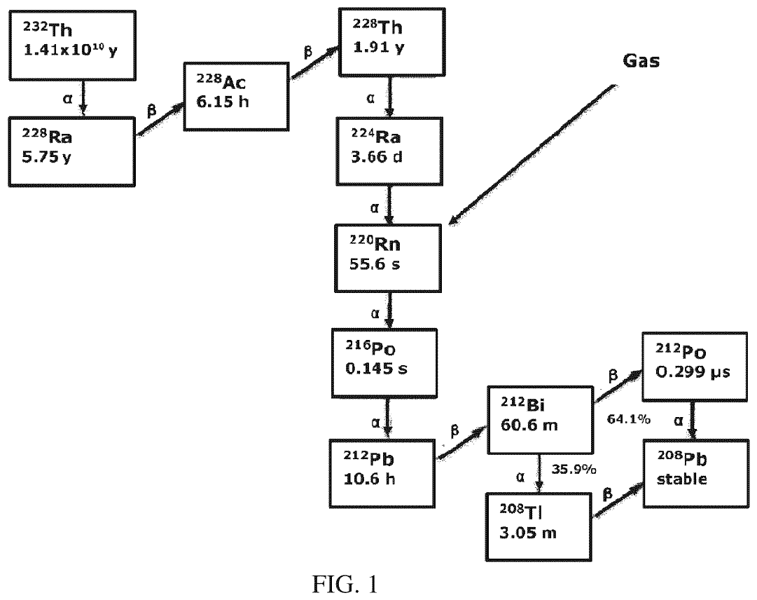

FIG. 1 depicts a diagram of an exemplary thorium series decay chain beginning with thorium 232 (²³²Th). The half-life of each radionuclide in the decay chain is noted in the figure. Note that the radon 220 radionuclide (²²⁰Rn) rapidly decays (e.g., a half-life of 55.6 seconds) into polonium 216 (²¹⁶Po), which further quickly decays (e.g., a half-life of 0.145 seconds) into a lead 212 radionuclide (²¹²Pb). It will further be noted from FIG. 1 that 220Rn may be a gas at ambient pressure and temperature. Accordingly, it will be appreciated that when a source including a precursor radionuclide to ²²⁰Rn (e.g., ²²⁴Ra, ²²⁸Th, ²²⁸Ra, ²³²Th, or ²²⁸Ac) is exposed to a portion of a container (e.g., an interior surface), the precursor radionuclide may decay into the gaseous ²²⁰Rn. The gaseous ²²⁰Rn may then decay into (e.g., via ²¹⁶Po) ²¹²Pb and may deposit onto the exposed portion of the container as ²¹²Pb. Note that the materials described in FIG. 1 are exemplary, and that the gripper system described herein is suitable for use with any radionuclide-generating material and radionuclide generator wherein a container is inserted into the generator to collect of progeny radionuclides from the radionuclide-generating material of the generator for the subsequent use of the progeny radionuclides from the container.

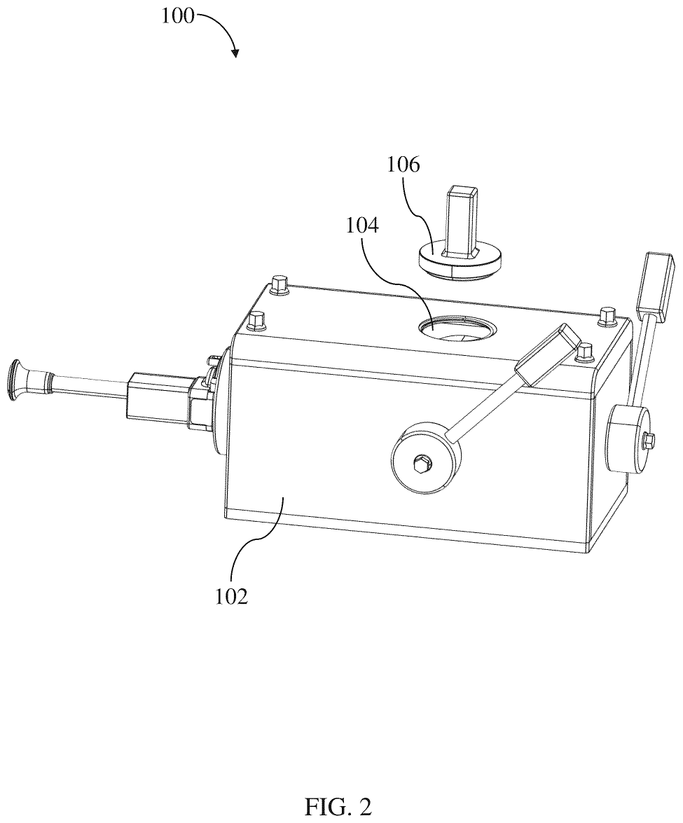

FIGS. 2 depicts a perspective view of a radionuclide generator 100 according to one embodiment. In the embodiment shown, the generator 100 may include a housing 102 configured to at least partially contain, surround, or otherwise house various portions of the generator 100. In some embodiments, the housing 102 may include a receptacle 104. The receptacle 104 may comprise an opening in the housing 102 through which a container may be passed in order to load the container into the generator 100 and/or to unload the container from the generator. In this regard, the receptacle 104 may be sized and shaped to receive a container and/or a holder and to allow the container and/or the holder to pass through the receptacle.

Additionally, the generator 100 may further comprise a loading cover 106. The loading cover 106 may be configured to selectively open and close the receptacle 104. For example, the loading cover 106 or a portion thereof may be partially insertable into and removable from the receptacle 104 to open and close the receptacle 104. In various embodiments, the loading cover may be selectively couplable to and/or retainable within the receptacle using snaps, latches, clasps, threads, detents, friction fittings, or any other appropriate interface. Further, the loading cover and receptacle may be configured to form a gas-tight seal when the loading cover is inserted into the receptacle. For example, at least one of the loading cover and the receptacle may include one or more gaskets, O-rings, compliant material, or any other appropriate type of seal. In some embodiments, both the loading cover and the receptacle may include gaskets, O-rings, or other seals to facilitate a seal when generating radionuclides within the generator.

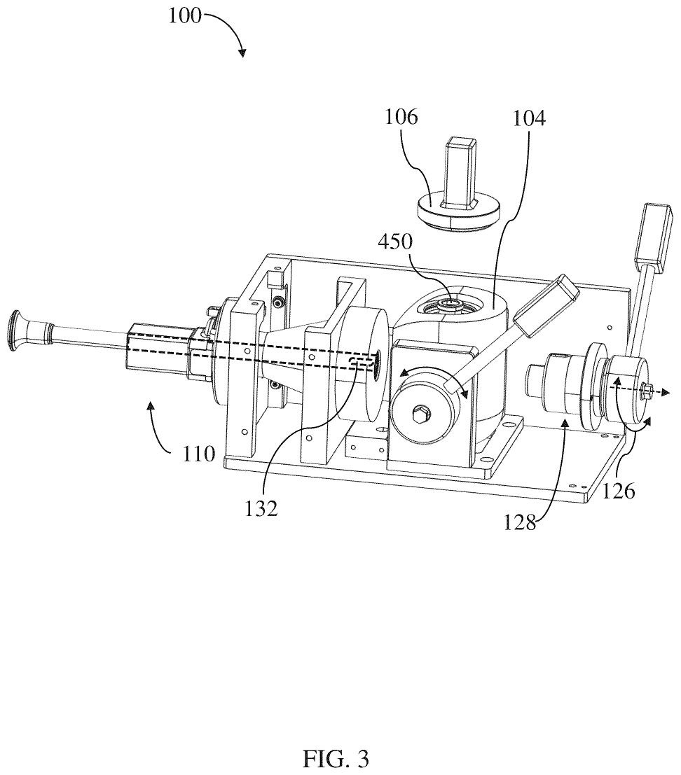

As further shown in the cutaway view of FIG. 3, a generator 100 may include a receptacle 104 and a source holder 110. The receptacle 104 may be configured to receive a container 450 disposed in a holder. The container receptacle 104 may be configured to receive the container 450 in a holder, for example, by including a cavity sized and shaped to receive the container 450 and holder. The container receptacle 104 may further be configured to move the container 450 within the container receptacle 104. In some embodiments, the container and/or the holder may be configured to move from a first pose to a second pose in order to expose an interior surface of the container while in the second pose to a radionuclide source 132 of the source holder 110. The second pose may comprise the opening of container 450 being configured to receive the portion of source holder 110 containing the radionuclide source 132.

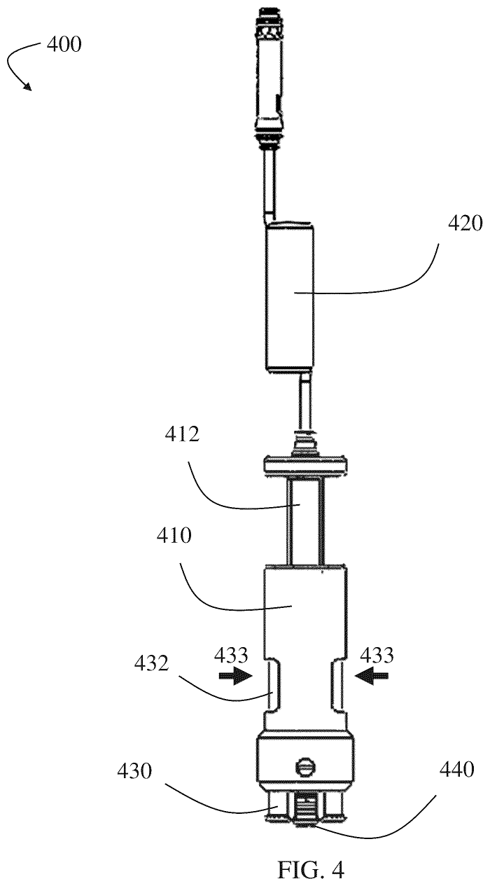

FIG. 4 is a schematic diagram showing a side view of gripper system 400 which may be used to position a holder with a container disposed therein into the receptacle 104 of the radionuclide generator 100 shown in FIG. 1. The system 400 shown in FIG. 4 comprises a body 410 comprising handle 412, vacuum source 420, one or more locks 430 configured to selectively engage a holder, and a seal 440. The vacuum source 420 may be configured to be connected to the seal 430 attached to the body 410 through one or more connection ports associated the body 410. The one or more locks 430 and other associated structures may either be integrally formed with or attached to the body 410 in any appropriate manner. The gripper system 400 may be sized and adapted to selectively grip a holder such that the holder may be selectively held on and released from the holder, in some embodiments. The holder may be correspondingly sized to fit into the receptacle 104 of a radionuclide generator 100 shown in FIG. 1 which is configured to receive the holder, in some embodiments. Thus, the gripper system 400 shown in FIG. 4 is sized and adapted to manipulate a holder which is further sized and adapted to be used with a radionuclide generator. Note that the gripper system, and the holder which may function synergistically with the gripper system, may be sized and adapted to operate with radionuclide generators configured to receive holders of different sizes.

For example, a maximum of each dimension (e.g., length, width, and height) of the holder may each independently be greater than or equal to 1 cm, greater than or equal to 2 cm, greater than or equal to 3 cm, greater than or equal to 5 cm, greater than or equal to 10 cm, or greater than or equal to 20 cm. According to some embodiments, a maximum of each dimension of the holder may each independently be less than or equal to 30 cm, less than or equal to 20 cm, less than or equal to 10 cm, less than or equal to or equal to 5 cm, less than or equal to 3 cm, or less than or equal to 2 cm. Combinations of the foregoing ranges are possible (e.g., greater than or equal to 1 cm and less than or equal to 30 cm). Other ranges are also possible. Likewise, the gripper system may be sized and adapted to facilitate the selective gripping of holders having any of the foregoing dimensions.

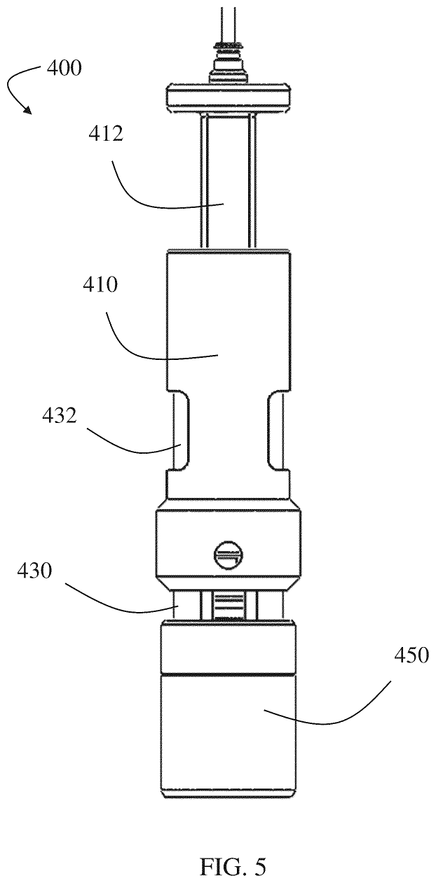

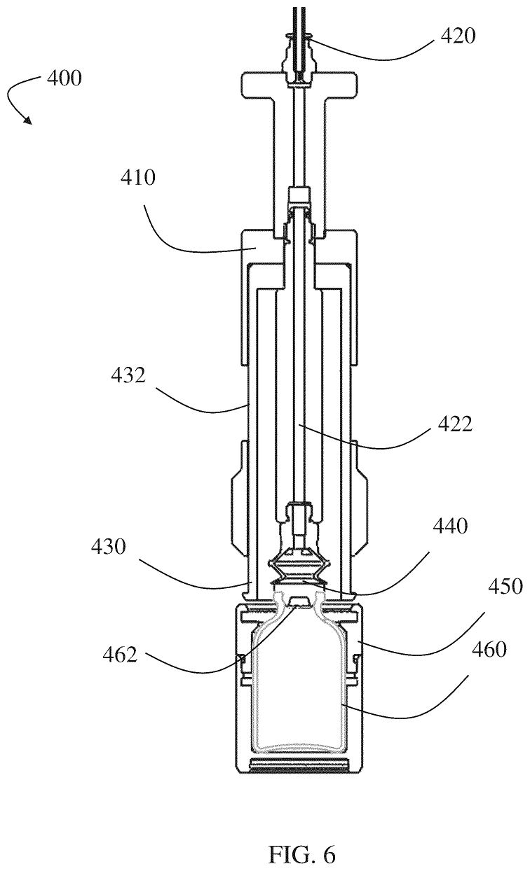

As best seen in FIGS. 5 and 6, the holder 450 may have an interior volume configured to receive a container 460, where the container, in accordance with some embodiments, may be configured to receive radionuclides from the radionuclide generator. The container, in some embodiments, may include a stopper 462 disposed in an opening of the container to maintain a sterility of the interior volume of the container until the stopper is removed. Specifically, preventing particles from entering the container may minimize and/or prevent contamination when using the container, for example, contamination of a workplace during a medical treatment and/or application of radionuclides contained within the container. In some embodiments, the presence of the stopper may be advantageous for maintaining a sterility of the interior volume of the container prior to exposure of the interior volume of the container to the radionuclide source. In some embodiments, for example, after an interior surface of the container has been exposed to a radionuclide source, radionuclides may be present on the interior surface of the container and thus the presence of the stopper may prevent the escape of radionuclides from the interior of the container and/or a deleterious impact between he radionuclides and viable and/or non-viable particles that may enter the interior volume container in the absence of the stopper.

As described above, in some embodiments, containers 460 configured to receive radionuclides from a radionuclide generator may have a standardized size and/or shape. In some cases, any container that is resistant to degradation from radiation may be used to capture radionuclides from a radionuclide generator. Accordingly, in some embodiments, the container may be any of a variety of sizes, as long as it is capable of being operatively coupled with the radionuclide generator that is used to produce the radionuclides. The container may define an interior volume having an interior surface, for example, on which radionuclides may be deposited from a radionuclide generator, in accordance with some embodiments.

Returning to FIG. 4, the various components of the gripper system 400, e.g., the body 410, the handle 412, the one or more locks 430, and/or the seal 440, may comprise any of a variety of materials, as long as the materials are resistant to radiation. Materials that are suitable for use for the various components of the gripper system include metals (e.g., aluminum) and polymers (e.g., polyether ether ketone, PEEK). Other materials are also possible, as this disclosure is not so limited. In some embodiments, at least a portion of the body of the gripper system comprises PEEK, for example, an outer sleeve of the body. In some embodiments, an interior portion of the body of the system, e.g., the cantilever beams, may comprise aluminum. In some embodiments, the handle of the gripper system comprises aluminum and/or PEEK.

As noted above, in some embodiments, the gripper system 400 may be configured to selectively engage with the holder 450. The gripper system 400, in accordance with some embodiments, may have one or more locks 430 to engage with the holder. In some embodiments, the one or more locks 430 may be configured to selectively engage (e.g., lock) with the holder 450. The locks 430 may have multiple configurations, for instance, a locked configuration and an unlocked configuration. Accordingly, in some embodiments, the one or more locks 430 of the gripper system may be selectively moved between a locked and unlocked configuration to selectively engage and release the holder 450. In some cases, the lock 430 may advantageously prevent relative movement of the holder 450 relative to the gripper system 400 when the holder is engaged with the gripper system.

It should be understood that any of a variety of locks may be used with the gripper system, in accordance with some embodiments, as long as the lock is configured to reversibly lock and unlock, allowing for the selective gripping of the holder by the gripper system. Of course, in accordance with some such embodiments, there may be a corresponding portion of the one or more locks of the gripper system on the holder. Examples of the one or more locks include one or more detents, latches, cantilever beams and corresponding hooks, magnetic connectors, components with interlocking geometries, and/or any other appropriate type of lock that may be used to selectively engage with a corresponding portion of the holder as the disclosure is not so limited.

The one or more locks 430, in the embodiment shown in FIG. 4, are cantilever beam. The beams extend outward from the base of the gripper system through an internal channel or other interior cavity of the body 410 of the gripper system 400. To disengage the cantilever beams 432 when they are selectively engaged with a holder 450, exposed portions of the cantilever beams 432 accessible through one or more corresponding openings formed on the body 410 may be pressed inward in direction 433 by the user (e.g., by tongs and/or a manipulator used by a user). Applying a force in direction 433, in some embodiments, may change the gripper system from a locked to an unlocked configuration, e.g., when selectively gripping a holder, which may release the holder. For example, pressing the cantilever beams in with hooks formed on their distal end portions, may disengage the hooks from a corresponding rim or other mechanically interlocking feature formed on the holder to release the holder. As described elsewhere herein, other types of locks on the gripper system and corresponding locking features on the holder are possible, as this disclosure is not so limited.

FIG. 5 is a schematic diagram showing a side view of the gripper system 400 selectively engaged with a holder 450. FIG. 5 demonstrates that the gripper system is sized and adapted to selectively grip the holder 450.

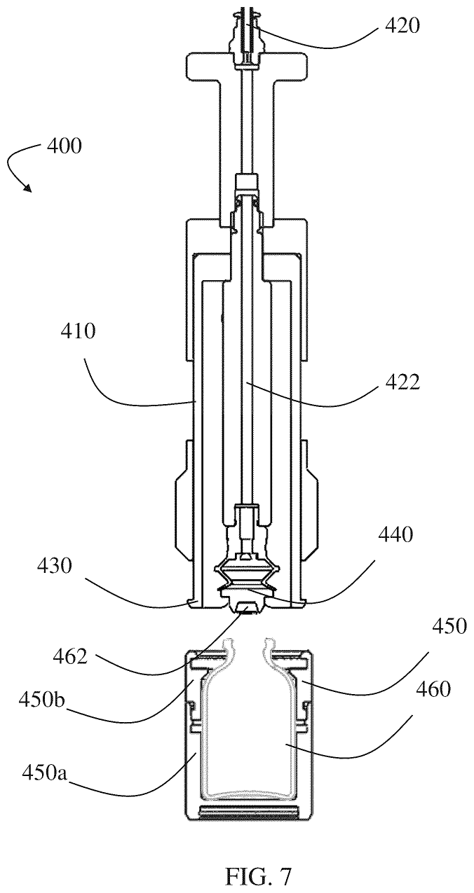

FIGS. 6-7 are schematic diagrams showing cross-sectional views of the gripper system that is shown in FIGS. 4-5. Similar to the above embodiment, these figures show a gripper system 400 comprising a body 410, a vacuum source 420, one or more locks 430 comprising cantilever beams, and a seal 440 selectively engaged with a holder 450. The holder 450 has a container 460 disposed therein, where an opening of the container 460 is closed with a stopper 462. The cross-sectional view shows that gripper system 400 further comprises an interior line 422 that allows for fluid connection between the vacuum source 420 to the seal 440. The vacuum source 440 produces a vacuum that is fluidically connected through interior line 422 to the seal 440 such that the vacuum generated by the vacuum source may be applied to the seal 440. The vacuum may be applied when the seal 440 is positioned against a stopper 462 of a container 460 such that a suction force may be applied to the stopper 462 to remove the stopper 462 from the opening of the container 460. For example, the stopper may be removed from the container after the holder with the container disposed therein is positioned within the radionuclide generator.

As noted previously above, while removing and/or replacing a stopper in an opening of the container is desirable when positioning and/or removing the container from the radionuclide generator, the stopper may be difficult to remove using the tongs and/or manipulators designed for use with the radionuclide generators. Accordingly, a gripper system 400 described herein may include a seal 440 configured to engage with a stopper 462 of a container 460 positioned in an opening of the container 460 when the gripper 400 is engaged with the holder 450 with the container 460 disposed therein. In some embodiments, the gripper system may further comprise a vacuum source 420 configured to apply a vacuum to the seal 440 when the seal 440 is positioned against the stopper 462 of the container 460, for example, through an interior line or other appropriate flow line that may be present in or associated with the body 410 of the gripper system 400. That is, the interior line 422, or other connection, may fluidically connect the vacuum source 420 to the seal 440, where the seal 440 is positioned against a stopper 462 that is positioned in the opening of a container 460 when the gripper system is engaged with a holder including a container disposed therein. Thus, once the holder 450 with the container 460 disposed therein is positioned within the radionuclide generator, the gripper system 400 may be configured to remove the stopper 462 from the container using the operatively seal and vacuum source.

In view of the above, removal of a stopper 462, in some embodiments, may include the holder 450 and the container 460 disposed therein being retained within the radionuclide generator, such as that described relative to FIGS. 2 and 3, by a force, e.g., a locking mechanism, friction, gravity, etc. Concomitantly, in some embodiments, the seal 440 of the gripper system 400 may be positioned against the stopper 462 of the container 460 while the vacuum source 420 applies a vacuum to the seal 440. The vacuum generated by the seal 440 and vacuum source 420 may apply a suction force to the stopper 462 which may be oriented in a direction that is at least partially opposite to the force retaining the holder and container within the radionuclide generator when the gripper system 400 is retracted from a holder 450 disposed in a generator. In some embodiments, the force retaining the holder 450 and the container 460 within the radionuclide generator is greater than the suction force. Accordingly, when the force retaining the holder 450 and container 460 in the radionuclide generator and the suction force are applied to the holder 450 and stopper 462 by the gripper system 400 in the unlocked configuration, i.e., the holder 450 has been released, the stopper 462 of the container 460 may be removed from the opening of the container 460 by the suction force while the container and holder are maintained in a desired position in the radionuclide generator. Note that removal of the stopper 462 occurs due to the suction force maintaining a position of the stopper relative to the gripper system 400 as the gripper system 400 is displaced away from the stationary holder 450 and container 460 disposed therein.

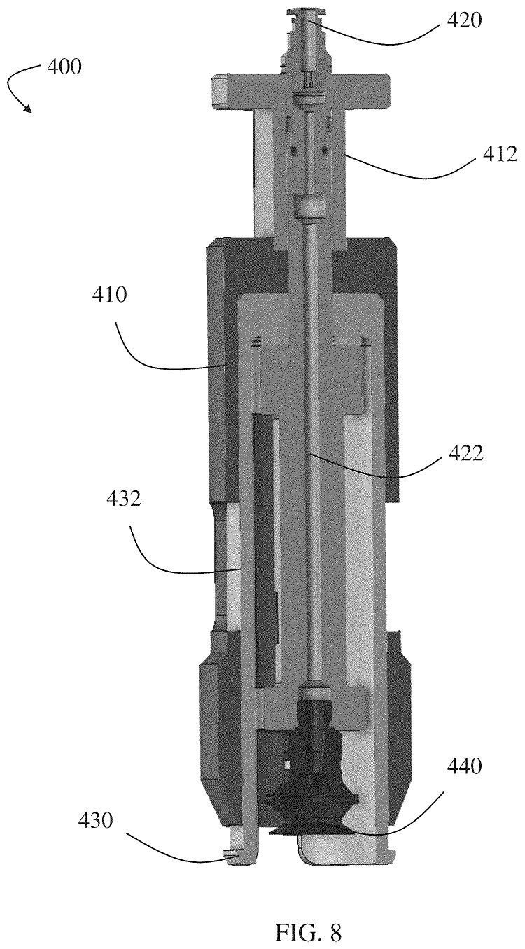

FIG. 7 shows a similar cross-sectional view of the gripper system as shown in FIG. 6. In FIG. 7, however, the gripper system 400 has been disengaged with the holder 450 with the container 460 disposed therein. FIG. 7 shows that, when the system 400 was disengaged with the holder 450 (e.g., the holder was released), the vacuum source 420 and seal 440 of the gripper system 400 applied a suction force to the stopper 462 such that the stopper 462 was removed from the opening of the container 460 and the stopper 462 was retained by the gripper system 400. FIG. 8 shows the gripper system 400 disengaged and removed from the holder.

In the depicted embodiment, vacuum source 420 and the seal 440, as described above, may be configured such that, when the gripper system 400 is selectively engaged with a holder 450 with a container 460 disposed therein, the vacuum source 420 may apply a vacuum to an external, or distal, side of the seal 440 that may be oriented towards and disposed against a corresponding surface of the stopper 462 of the container 460 oriented towards the gripper system 400 when the holder 450 is engaged with the gripper system 400. Again, applying a force (e.g., a suction force) in this manner may facilitate the removal of the stopper from the container when the gripper system 400 is displaced away from the holder 450 and container 460, as shown in FIG. 7.

In some embodiments, the seal 440 and the vacuum source 420 of a gripper system 400 may either be used to remove and replace a stopper 462 from a single container 460 and/or transfer stoppers 462 between different containers depending on a desired workflow. For example, in some embodiments, a gripper system 400 may release a first stopper removed from a container and may be used to remove a second stopper from a second container in a second holder that is not in the radionuclide generator while the first container in the first holder is positioned in the radionuclide generator (e.g., and capturing from the radionuclide source). Accordingly, the gripper system may then remove and retain a second stopper from the second container or other source. The gripper system may then be used to place the second stopper in the first container prior to transitioning into a locked configuration to remove the first holder and first container from the radionuclide generator with the second stopper positioned therein. In this manner, the exposure of the stopper that is used to close the opening of the container to an ambient environment (e.g., and any viable and/or non-viable particles in the ambient environment) may be minimized. For example, the second stopper may be removed and retained by the gripper system immediately before removing the first container and first holder from the radionuclide generator. Of course, it should be understood that a gripper system may be used to manipulate any combination of stoppers, containers, and/or holders as the disclosure is not limited to a particular workflow.

As further shown in the cross-sectional views of FIGS. 6 and 7, the holder 450 may include an interior volume that is sized and shaped to receive the container 460. In some embodiments, the container 460 is disposed within the interior volume of the holder 450. The holder 450 may be configured to retain the container disposed in an interior volume therein. In accordance with some embodiments, the holder 450 includes a first portion 451 and second portion 452, where the second portion 452 is configured to be removably attached to the first portion 451, where, when attached, the second portion 452 retains the container 460 within the interior volume of the holder. In some embodiments, the second portion includes an opening configured to permit at least a portion of the container 460 to extend therethrough while being smaller than another portion of the container 460 to maintain the container 460 in a desired pose within the holder 450. In some such embodiments, the portion of the container 460 may be a neck of the container 460. In some embodiments, the second portion 452 includes an opening configured to allow access to the container disposed within the holder. For example, as shown in the figures, a first portion 451 of the holder 450 may be sized and shaped such that the container 460 may be disposed at least partially within the first portion 451 of the holder 450. The second portion 452 of the holder may then be attached to the first portion 451 using an interference fit, threading, interlocking mechanical features, magnetic connectors, and/or any other appropriate type of connection. Thus, the first and second portions may cooperate to maintain the container 460 disposed at least partially in the interior volume of the holder 450.

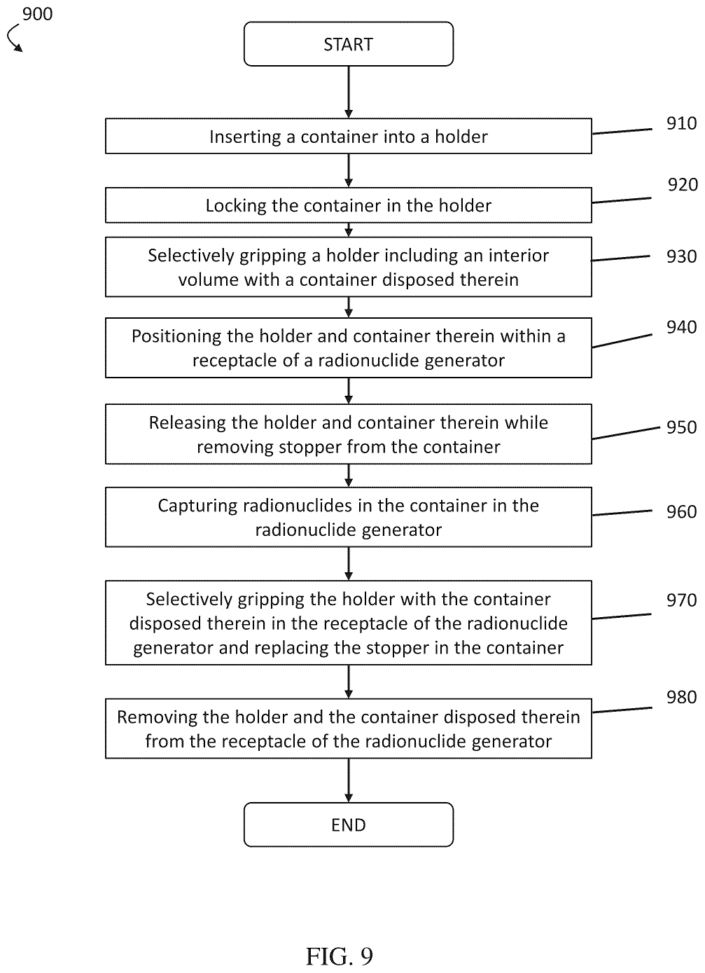

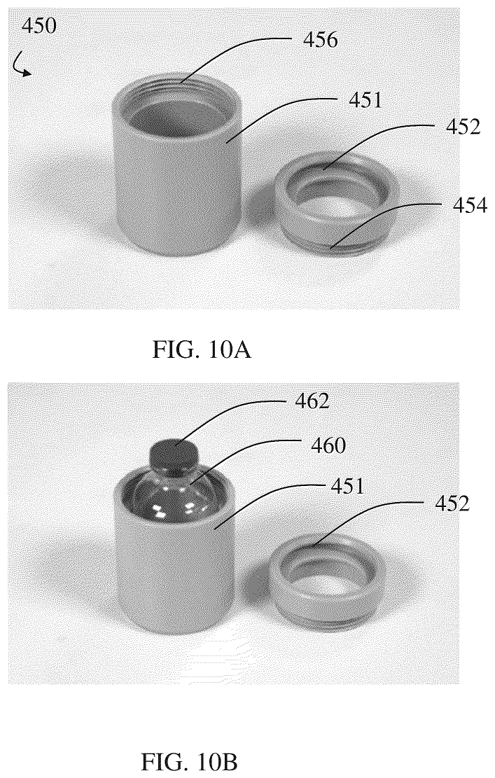

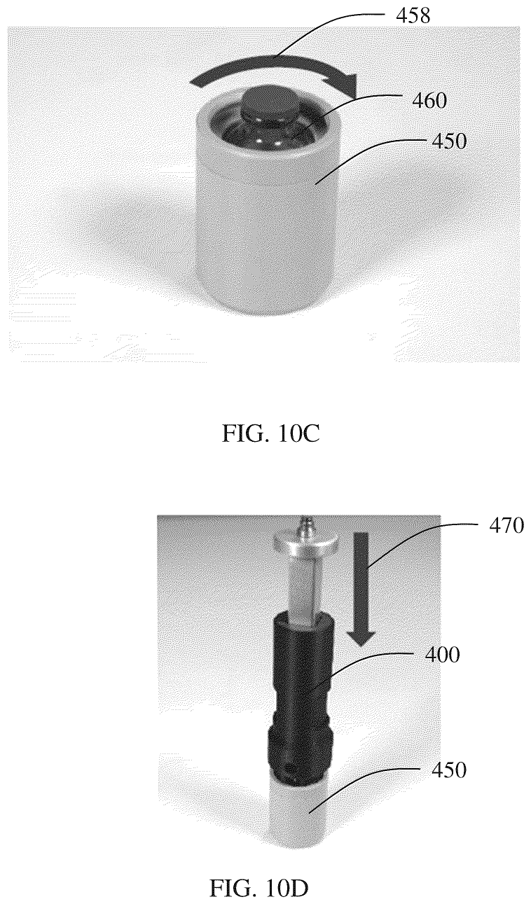

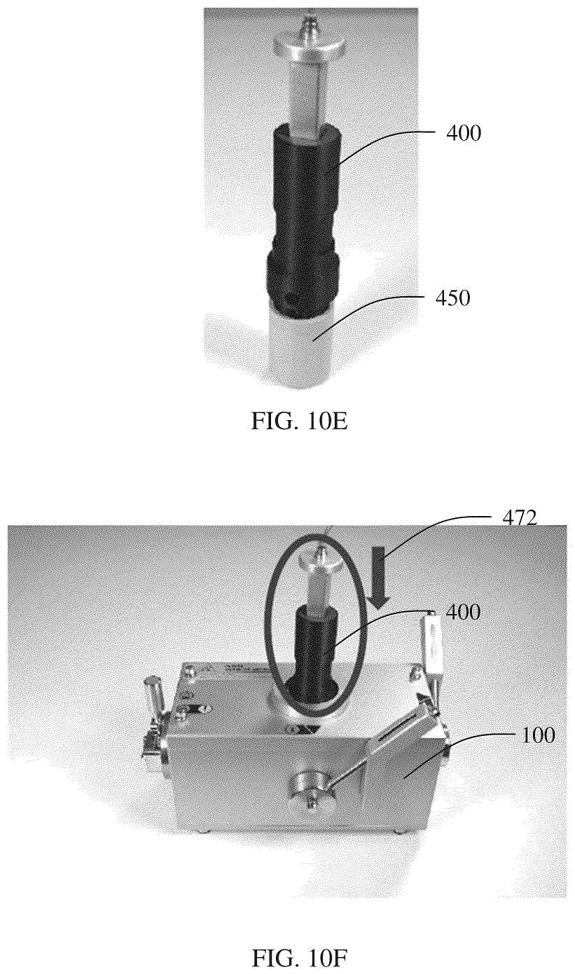

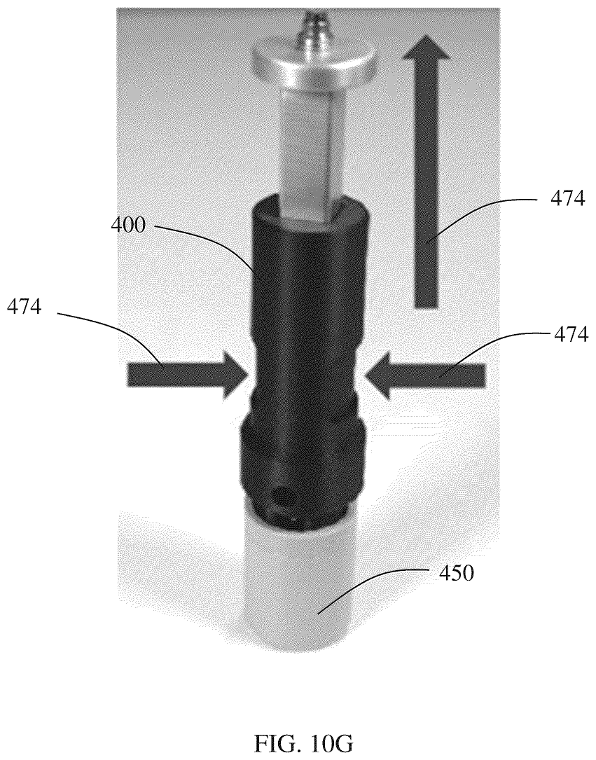

FIG. 9 is a method flow diagram of method 900 associated with using gripper system. Note that, in some embodiments, the methods described herein may comprise some and/or all of the steps shown in FIG. 9. Additional methods steps that are not shown in FIG. 9 are possible in combination with some and/or all of the steps shown in method 900 of FIG. 9, in some embodiments. FIGS. 10A-10G shows corresponding images of a system being used according to one or more of the steps of method 900 in FIG. 9. Note that some and/or all of the steps recited in the method 900 may be performed using tongs and/or a manipulator such that a user may not directly contact the holder, the container, the radionuclide generator, and/or any other component of the system. However, manual manipulation of the disclosed holders is also contemplated.

The method 900 of FIG. 9 includes inserting a container 460 into holder 450 at 910. FIG. 10A shows the holder 450 includes a first portion 451 and a second portion 452 of the holder removed from the holder. The second portion 452 includes threading 454 that connects with threading 456 on the first portion 451 of holder 450. FIG. 10B shows the container 460 disposed in an interior volume the first portion 451 of holder 450, the container 460 includes a stopper 462 in an opening of the container 460 such that the container remains closed and an interior volume of the container 460 may remain sterile while the stopper 462 remains in the opening of the container. Note that the removal of the second portion 452 from the first portion 451 may permit the insertion or removal of the container 460 in the first portion 451.

The method 900 in FIG. 9 may include locking the container 460 in the holder 450 at 920. For example, as shown in FIGS. 10B and 10C, the container 460 may be disposed in an interior volume of the holder 450 formed between the first portion 451 of the holder 450 and the second portion 452 of the holder 450. The second portion 452 of the holder may then be connected to the first portion 451 of the holder to retain the container 460 in the holder 450 (e.g., via the illustrated threading). Thus, the second portion 452 may be locked onto the first portion 451 of the holder 450 after container 460 has been disposed therein, as shown in FIG. 10C. Once the first a second portions 451 and 452 of the holder are connected, the second portion 452 may retain the container within the interior volume of the holder while permitting at least a portion of the container, e.g., the neck as shown in FIG. 10C, to extend through an opening of the second portion 452. Other connections for reversibly attaching the first and second portions of the holder may be used as noted previously above.

Once the container 460 is positioned in the holder 450, the method 900 may include selectively gripping the holder 450 with the container 460 disposed therein at 930, an image of which is shown in FIG. 10D. For example, the gripper system 400 may be displaced towards the holder 450 by a downward force 470 such that the gripper system 400 selectively grips holder 450 using an appropriate type of lock as detailed previously above. Following the downward force 470 to facilitate the gripping of holder 450 by gripper system 400, the gripper system 400 may be engaged with and retain the holder 450 as shown in FIG. 10E in the locked configuration.

Again, in some embodiments, the holder may be sized and shaped to receive a container that may have a non-standard size and/or that may not be suitable for use with the radionuclide generator without the presence of the holder, and thus the holder facilitates the use of the container with the radionuclide generator. In this manner, in some embodiments, various holders having different interior volumes configured to receive standard and/or non-standard sized containers may be available for use with the gripper system and/or radionuclide generator, as the holder may be sized and adapted for use with the gripper system and/or the radionuclide generator whereas the container might not be. For example, a first holder may be sized and adapted to receive a first container having a first size, whereas a second holder may be sized and adapted to receive a second container having a second size different from the first size. The first and second holders may have interior volumes that differ in size to accommodate the corresponding containers, but the first and second holders may have substantially the same maximum dimensions (e.g., height, width, length) so that each holder may be selectively gripped by the gripper system and positioned in the radionuclide generator thereafter as described elsewhere herein.

In some embodiments, a holder having a large interior volume configured to receive a first container. In some embodiments, a spacer may be positioned in the interior volume of the holder such that the holder with the spacer disposed therein is sized and adapted to receive a second container having a smaller size than the first container. The spacer, in some embodiments, may be retained within the interior volume of the holder by an adhesive, friction, a locking mechanism, or other forces. Various sizes of spacers may be possible, for example, to adjust the interior volume of the holder to be configured to receive various sizes of containers that are not sized and adapted to be selectively gripped by the gripper system.

Following engagement and retention of the holder 450 with the container 460 disposed therein by the gripper system 400, the method 900 may further include positioning the holder 450 and container 460 disposed therein within a receptacle of a radionuclide generator at 940. FIG. 10F shows the gripper system 400 positioning the holder 450 into a receptacle 104 of the radionuclide generator 100. Downward force 472 is applied to gripper system 400 to position the holder 450 and container 460 disposed therein into the radionuclide generator 100.

Following positioning of the holder 450 and container 460 within the receptacle of the radionuclide generator, the method 900 may include releasing the holder 450 and container 460 therein while removing stopper 462 from the container 460 at 950. Such a release of the holder and removal of the stopper by the gripper system is shown in the schematic diagrams shown in FIGS. 6 and 7. Additionally, FIG. 10G shows the manner in which forces 474 may be applied to the lock (e.g., the illustrated cantilevered locking legs) to move the lock to an unlocked configuration. In the unlocked configuration, the gripper system 400 releases the holder 450. Note that, in FIG. 10G, the gripper system 400 and holder 450 are not positioned within the radionuclide generator for clarity. However, similar forces may be applied to gripper system 400 in FIG. 10F to release the holder 450 and container 460 disposed therein from the gripper system 400 while the holder 450 and container 460 are positioned within the radionuclide generator 100. The radionuclide generator may thereafter be used to expose an interior surface of the container to a radionuclide source, in some embodiments.

Exposing the interior surface of the container 460 to the radionuclide source in the radionuclide generator may include multiple steps. For example, according to some embodiments, the loading cover 106 as shown in FIGS. 2 and 3 may be placed over the receptacle containing the holder 450 and container 460 therein such that the holder 450 and container 460 are in the radionuclide generator in a first pose. The holder 450 and container 460 may then be repositioned from a first pose to a second pose by the radionuclide generator such that the radionuclide source material 132 of source holder 110 may be inserted into the opening of the container 460 and expose the interior surface of the container 460 to the radionuclide source material 132 such that the container receives radionuclides. That is, the method 900 shown in FIG. 9 may further include capturing radionuclides in the container 460 in the radionuclide generator at 960. Accordingly, while the container may be any of a variety of standard or non-standard sizes, the opening of the container may be sized and configured to receive a distal end of the radionuclide source holder including the radionuclide source, e.g., after the stopper 462 is removed from the opening when positioning the holder 450 and container 460 in the radionuclide generator.

Following exposure to the radionuclide source material, the container 460 may contain radionuclides (e.g., ²¹²Pb). The radionuclide-containing container 460 positioned within the holder 450 may then be repositioned from the second pose to the first pose within the radionuclide generator. The loading cover 106 may then be removed from the radionuclide generator such that the holder 450 and container 460 disposed therein are once again accessible from the exterior of the radionuclide generator, in some embodiments. The method 900 may include selectively gripping the holder 450 with the container 460 disposed therein within the receptacle of the radionuclide generator and replacing the stopper 462 in the opening of the container 460 at 970. In some such embodiments, the stopper 462 that was originally removed when positioning the holder 450 and container 460 disposed therein into the radionuclide generator may be replaced into the opening of the container 460.

While a single container 460 and stopper 462 are described above, in some embodiments, the stopper 462 that is removed by the gripper system 400 from the holder 450 and container 460 disposed therein in the radionuclide generator is a first stopper removed from a first holder 450 and first container 460. Subsequent to the first stopper being removed, a similar process may be performed on a second holder and second container disposed therein to remove a second stopper from the second container when releasing the second holder and second container. The second stopper may be retained by the gripper system if the vacuum source 420 and seal 440 maintain the applied force (e.g., a suction force) to the second stopper, and then placed in the opening of the first container 460 in the first holder 450 that is removed from the radionuclide generator after the first container captures radionuclides. This may minimize and/or prevent viable and/or non-viable particles from collecting on the stopper that is positioned in the opening of the container after capturing radionuclides with the container.

Finally, the method 900 in FIG. 9 may include removing the holder 450 and the container 460 disposed therein from the receptacle of the radionuclide generator at 980. In some such embodiments, the container with radionuclides disposed therein may then be configured for use for various applications including, for example, medical treatments involving radionuclides (e.g., TAT).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present Invention.

1. A gripper system for manipulating a container of a radionuclide generator, comprising:
one or more locks configured to selectively engage with and retain a holder including an interior volume sized and shaped to receive the container disposed therein;
a seal configured to engage with a stopper positioned in an opening of the of the container when the gripper is engaged with the holder with the container disposed therein; and
a vacuum source configured to apply a vacuum to the seal when the seal is positioned against the stopper of the container.

2. A gripper system for manipulating a container of a radionuclide generator, comprising:
a holder including an interior volume sized and shaped to receive the container disposed therein, wherein the holder includes a first portion and a second portion configured to be removably attached to the first portion, wherein the second portion includes an opening formed therein configured to permit a neck of the container to extend through the opening while retaining the container in the interior volume of the holder; and
one or more locks configured to selectively engage with and retain the holder.

3. The gripper system of claim 2, further comprising a seal configured to engage with a stopper positioned in an opening of the container when the gripper is engaged with the holder with the container disposed therein.

4. The gripper system of claim 2, further comprising a vacuum source configured to apply a vacuum to the seal when the seal is positioned against the stopper of the container.

5. The gripper system of claim 1, further comprising a gripper body wherein the one or more locks and the seal are attached to the gripper body, and wherein in a locked configuration the one or more locks are configured to retain the holder on the gripper body and wherein in an unlocked configuration the one or more locks are configured to release the holder from the gripper body.

6. The gripper system of claim 5, wherein the vacuum source and seal are configured to apply a force to remove the stopper from the opening of the container when the one or more locks are in the unlocked configuration and the gripper body is moved away from the holder and the container disposed therein.

7. The gripper system of claim 5, wherein the one or more locks are configured to be actuated between the locked configuration and the unlocked configuration.

8. The gripper system of claim 1, wherein the seal includes at least one selected from an O-ring, a conical elastomeric seal, and a compliant material.

9. The gripper system of claim 1, wherein the vacuum source is fluidly coupled to a distal surface of the seal, wherein the distal surface of the seal is oriented towards the container when the one or more locks are engaged with the holder.

10. The gripper system of claim 1, wherein the one or more locks are one or more detents, latches, cantilever beams and corresponding hooks, magnetic connectors, and/or components with interlocking geometries.

11. The gripper system of claim 1, wherein the holder is configured to be placed inside of a correspondingly sized and shaped portion of a radionuclide generator.

12. The gripper system of claim 1, further comprising the holder.

13. The gripper system of claim 12, further comprising the container disposed in the interior volume of the holder, and the stopper disposed in the opening of the container.

14. The gripper system of claim 1, wherein the holder is configured to retain the container disposed in the interior volume of the holder.

15. A method, comprising:
selectively gripping a holder including an interior volume with a container disposed therein with a gripper system;
positioning the holder including the container within a receptacle of a radionuclide generator; and
releasing the container and the holder while removing a stopper from the container with the gripper system.

16. A method, comprising:
receiving a container within an interior volume of a first portion of a holder;
selectively attaching a second portion of the holder to the first portion such that a neck of the container extends through an opening of the second portion;
retaining the container in the interior volume of the first portion of the holder with the second portion;
selectively gripping the holder with a gripper system; and
positioning the holder including the container within a receptacle of a radionuclide generator using the gripper system.

17. The method of claim 15, further comprising engaging a seal of the gripper system with a stopper of the container.

18. The method of claim 17, wherein engaging the seal with the stopper includes applying a suction force to the stopper using a vacuum source.

19. The method of claim 18, wherein removing the stopper of the container includes moving the gripper system relative to the holder while the suction force is applied to the stopper.

20. The method of claim 15, wherein the stopper of the container is a first stopper of a first container, the method further comprising selectively gripping a second container disposed in a second holder; releasing the second container and second holder and removing a second stopper from the second container; and selectively gripping the first container and attaching the second stopper to the first container.

21. The method of claim 15, wherein selectively gripping the holder includes gripping the holder with one or more locks of the gripper system to retain the holder on a gripper body of the gripper system.

22. The method of claim 15, wherein positioning the container and holder within the receptacle of the radionuclide generator comprises positioning the container in a first pose.

23. The method of claim 22, further comprising moving the container and holder within the radionuclide generator from the first pose to a second pose.

24. The method of claim 23, further comprising exposing an interior surface of the container to a radionuclide source in the radionuclide generator when the container is in the second pose.

25. The method of claim 23, further comprising moving the container with radionuclides disposed therein within the radionuclide generator from the second pose to the first pose.

26. The method of claim 15, further comprising selectively gripping the container and closing the container with a second stopper.

27. The method of claim 15, wherein the container is sterile.

28. The method of claim 21, wherein releasing the container includes moving the one or more locks of the gripper system from a locked configuration to an unlocked configuration.
